(19) United States
(12) Patent Application Publication
(10) Pub. No.: US 2019/0122423 A1
(43) Pub. Date: Apr. 25, 2019

(54) Method and Device for Three-Dimensional Presentation of Surveillance Video

(71) Applicant: Hangzhou Hikvision Digital Technology Co., Ltd., Hangzhou, Zhejiang (CN)

(72) Inventors: Jie Chen, Hangzhou, Zhejiang (CN); Quanzhan Wang, Hangzhou, Zhejiang (CN)

(73) Assignee: Hangzhou Hikvision Digital Technology Co., Ltd., Hangzhou, Zhejiang (CN)

(21) Appl. No.: 16/093,750

(22) PCT Filed: Dec. 13, 2016
(86) PCT No.: PCT/CN2016/109630

§ 371 Date: Oct. 15, 2018

(30) Foreign Application Priority Data
Apr. 21, 2016 (CN) 201610251261.X

(51) Int. Cl. G06T 17/00; G06T 19/20; G06K 9/00

(52) U.S. Cl. CPC G06T 17/00; G06K 9/00671; G06K 9/00771; G06T 19/20

(57) ABSTRACT

Embodiments of the present application provide a method and apparatus for three-dimensional presentation of a surveillance video, applicable to an electronic device. The method includes: acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model; dividing, according to the video grid information, the video image of the surveillance video into a plurality of image areas of corresponding sizes, and adjusting the image areas based on the area coordinates of the image areas in the three-dimensional background model, which are included in the video grid information; and superimposing the adjusted image areas on areas with corresponding coordinates in the three-dimensional background model. The surveillance video can be deeply integrated with the three-dimensional background model. A better three-dimensional presentation of the surveillance video is provided.

The present application claims the priority to a Chinese patent application No. 201610251261.X, filed with the State Intellectual Property Office of the People's Republic of China on Apr. 21, 2016 and entitled “METHOD AND DEVICE FOR THREE-DIMENSIONAL PRESENTATION OF SURVEILLANCE VIDEO”, which is incorporated herein by reference in its entirety.

### TECHNICAL FIELD

The application relates to the technical field of video surveillance, and in particular to a method and apparatus for three-dimensional presentation of a surveillance video.

### BACKGROUND

With the development of video technology, a method for three-dimensional presentation of a video (i.e., a method for simulating a real, dynamic three-dimensional scene through processing a two-dimensional video image) is increasingly used. For example, in the field of video surveillance, the three-dimensional presentation of a surveillance video captured by a video capture device can provide a user with a more intuitive view of the video image of the scene under surveillance.

Related methods for three-dimensional presentation of a surveillance video typically include only a three-dimensionalization of a scene under surveillance. That is, a corresponding three-dimensional background model is pre-established for each scene under surveillance. During the presentation of the surveillance video captured for each scene under surveillance, the three-dimensional background model of the scene is first presented. The captured surveillance video is then presented in its entirety on the three-dimensional background model in the form of a pop-up window, in order to achieve the purpose of three-dimensional presentation of the surveillance video.

However, in the methods described above, the surveillance video is still separated from the three-dimensional background model, in which each frame of the surveillance video is present in its entirety on the three-dimensional background model. Accordingly, the surveillance video cannot be deeply integrated with the three-dimensional background model. The three-dimensional presentation of the surveillance video is not intuitive.

### SUMMARY

Embodiments of the present application are aimed to provide a method and apparatus for three-dimensional presentation of a surveillance video to improve the performance of the three-dimensional presentation of the surveillance video. The specific technical solutions are as follows.

In a first aspect, an embodiment of the present application provides a method for three-dimensional presentation of a surveillance video applicable to an electronic device, the method includes:

acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model;

dividing, according to the video grid information, the video image of the surveillance video into a plurality of image areas of corresponding sizes, and adjusting the image areas based on the area coordinates of the image areas in the three-dimensional background model, which are included in the video grid information; and

superimposing the adjusted image areas on areas with corresponding coordinates in the three-dimensional background model.

Further, acquiring a preconfigured three-dimensional background model and video grid information corresponding to a scene in which the surveillance video is captured includes:

acquiring a preconfigured three-dimensional background model and video grid information that are encapsulated in the surveillance video and correspond to the scene in which the surveillance video is captured; and

determining identification information of a video capture device that captures the surveillance video, and then acquiring, from a preset storage space, a three-dimensional background model and video grid information corresponding to the identification information.

Further, configuring the three-dimensional background model includes:

receiving scene information input by a user, wherein the scene information includes at least information about a size of the scene and information about sizes and positions of fixed reference objects in the scene; and

generating the three-dimensional background model according to the scene information input by the user.

Further, configuring the video grid information includes:

acquiring a sample surveillance video;

superimposing the sample surveillance video on the three-dimensional background model;

receiving a division command input by the user, dividing a video image in the sample surveillance video into a plurality of image areas, and recording sizes of the image areas; and

receiving an adjusting command input by the user, generating the video grid information according to the area coordinates of the image areas before adjusting and of the image areas after adjusting, in the three-dimensional background model.

Further, when acquiring a preconfigured three-dimensional background model and video grid information that are encapsulated in the surveillance video and correspond to the scene in which the surveillance video is captured in the process of acquiring a preconfigured three-dimensional background model and video grid information corresponding to a scene in which the surveillance video is captured, the method further includes:

transmitting the three-dimensional background model and video grid information to the video capture device that captures the surveillance video, so as to cause the video capture device to encapsulate the three-dimensional background model and video grid information in the surveillance video.

In a second aspect, an embodiment of the present application provides an apparatus for three-dimensional presentation of a surveillance video applicable to an electronic device, the apparatus includes:

a first acquiring module, configured to acquire a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model;

a processing module, configured to divide, according to the video grid information, the video image of the surveillance video into a plurality of image areas of corresponding sizes, and adjust the image areas based on the area coordinates of the image areas in the three-dimensional background model, which are included in the video grid information; and

a first superimposing module, configured to superimpose the adjusted image areas on areas with corresponding coordinates in the three-dimensional background model.

Further, the first acquiring module includes:

a first acquiring sub-module, configured to acquire a preconfigured three-dimensional background model and video grid information that are encapsulated in the surveillance video and correspond to the scene in which the surveillance video is captured; and

a second acquiring sub-module, configured to determine identification information of the video capture device that captures the surveillance video, and then acquire, from a preset storage space, a three-dimensional background model and video grid information corresponding to the identification information.

Further, the apparatus further includes:

a receiving module, configured to receive scene information input by a user, wherein the scene information includes at least information about a size of the scene and information about sizes and positions of fixed reference objects in the scene; and

a first generating module, configured to generate the three-dimensional background model according to the scene information input by the user.

Further, the apparatus further includes:

a second acquiring module, configured to acquire a sample surveillance video;

a second superimposing module, configured to superimpose the sample surveillance video on the three-dimensional background model;

an analyzing module, configured to receive a division command input by the user, divide a video image in the sample surveillance video into a plurality of image areas, and record sizes of the image areas; and

a second generating module, configured to receive an adjusting command input by the user, generate the video grid information according to the area coordinates of the image areas before adjusting and of the image areas after adjusting, in the three-dimensional background model.

Further, the apparatus further includes:

a transmitting module, configured to transmit the three-dimensional background model and video grid information to the video capture device that captures the surveillance video, so as to cause the video capture device to encapsulate the three-dimensional background model and video grid information in the surveillance video.

In a third aspect of the present application, a storage medium is provided. The storage medium is configured to store executable program code, which performs the method for three-dimensional presentation of a surveillance video as provided in the first aspect when being executed.

In a fourth aspect of the present application, an application program is provided. The application program is configured to perform the method for three-dimensional presentation of a surveillance video as provided in the first aspect when being executed.

In a fifth aspect of the present application, an electronic device is provided, including:

a processor, a memory, a communication interface, and a bus;

the processor, the memory and the communication interface connect and communicate with each other through the bus;

the memory is configured to store executable program code; the processor is configured to read the executable program code stored in the memory to execute the executable program code, in order to perform the method for three-dimensional presentation of a surveillance video as provided in the first aspect.

A method and apparatus for three-dimensional presentation of a surveillance video are provided in embodiments of the present application. The method includes: acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model; dividing, according to the video grid information, the video image of the surveillance video into a plurality of image areas of corresponding sizes, and adjusting the image areas based on the area coordinates of the image areas in the three-dimensional background model, which are included in the video grid information; and superimposing the adjusted image areas on areas with corresponding coordinates in the three-dimensional background model. In embodiments of the present application, the video grid information includes sizes of image areas in the video image of the surveillance video, and area coordinates of the image areas in the three-dimensional background model. Each of the image areas can be adjusted based on the area coordinates of the image areas in the three-dimensional background model, which are included in the grid information, so that the image areas can fit with the three-dimensional background model. The adjusted image areas are further superimposed on areas with corresponding coordinates in the three-dimensional background model. As such, the surveillance video can be deeply integrated with the three-dimensional background model. A better presentation of the surveillance video is provided.

### BRIEF DESCRIPTION OF THE DRAWINGS

To describe the solutions of embodiments of the present application and the prior art more clearly, the accompanying drawings to be used in the embodiments and the prior art are described briefly below. Obviously, the accompanying drawings described below are merely some embodiments of the application, based on which those skilled in the art can obtain other drawings without creative efforts.

FIG. 1 is a flowchart of a method for three-dimensional presentation of a surveillance video provided by an embodiment of the present application;

FIG. 2 is another flowchart of a method for three-dimensional presentation of a surveillance video by an embodiment of the present application;

FIG. 3 is a structural schematic diagram of an apparatus for three-dimensional presentation of a surveillance video provided by an embodiment of the present application;

FIG. 4 is another structural schematic diagram of an apparatus for three-dimensional presentation of a surveillance video provided by an embodiment of the present application;

FIG. 5 is a structural schematic diagram of an electronic device provided by an embodiment of the present application.

### DETAILED DESCRIPTION

In order to provide a better three-dimensional presentation of a surveillance video, embodiments of the present application provide a method and apparatus for three-dimensional presentation of a surveillance video.

Technical solutions in the embodiments of the present application are clearly and completely described below with reference to the accompanying drawings in the embodiments of the present application. Obviously, the described embodiments are merely a part of but not all the embodiments of the present application. All other embodiments obtained without creative efforts in view of the embodiments of the present application by those skilled in the art fall within the scope of the present application.

It is noted that the embodiments of the present application and the features therein may be combined with each other when no conflict occurs. With reference to the accompanying drawings, a detailed description of the present application is provided in conjunction with the embodiments.

In order to provide a better three-dimensional presentation of a surveillance video, a method for three-dimensional presentation of a surveillance video is provided in an embodiment of the present application. As shown in FIG. 1, the method includes following steps:

S101, acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model.

The method provided in the embodiment of the present application can be applicable to an electronic device. Specifically, the electronic device may include, for example, a notebook computer, a smart terminal, a desktop computer, a portable computer, and the like.

In the embodiment of the present application, in order to provide a better three-dimensional presentation of a surveillance video, for each scene under surveillance, the electronic device can preconfigure a three-dimensional background model and video grid information corresponding to the scene under surveillance, so that during presentation of the surveillance video captured in the scene, the surveillance video is presented according to the three-dimensional background model and video grid information corresponding to the scene under surveillance. A better three-dimensional presentation of the surveillance video is thus obtained.

It is noted that the scene under surveillance described above may be an indoor scene or an outdoor scene, which is not limited in the embodiment of the present application.

In this embodiment of the present application, the three-dimensional background model corresponding to the scene under surveillance can be generated based on the prior arts, the detail of which is thus omitted herein.

The three-dimensional background model described above may be a model representing a scene with a polygon, which has a certain three-dimensional stereoscopic effect. The video grid information described above can be used to represent position mapping relation of the two-dimensional video images in the three-dimensional background model. Specifically, the grid information can include the sizes of image areas in a video image of the surveillance video, and the area coordinates of the image areas in the three-dimensional background model.

In this embodiment of the present application, the electronic device can first acquire a surveillance video, a preconfigured three-dimensional background model and video grid information corresponding to a scene in which the surveillance video is captured, so as to provide a better three-dimensional presentation of the surveillance video according to the acquired three-dimensional background model and video grid information. In this embodiment of the present application, a scene in which the surveillance video is captured can be referred to as a scene for the acquired surveillance video.

Specifically, during the acquisition of the surveillance video, the electronic device can acquire a surveillance video captured in real time by a video capture device; or acquire a surveillance video stored therein from a storage device.

S102, dividing, according to the video grid information, the video image in the surveillance video into a plurality of image areas of corresponding sizes, and adjusting the image areas based on the area coordinates of the image areas in the three-dimensional background model, which are included in the video grid information.

After acquiring the surveillance video, the three-dimensional background model and the video grid information corresponding to the surveillance video, the electronic device divides a video image in the surveillance video, according to the video grid information, into a plurality of image areas of corresponding sizes; and adjusts the image areas based on the area coordinates of the image areas in the three-dimensional background model, which are included in the video grid information.

It is noted that each scene under surveillance may contain some fixed reference objects, such as the walls, floor, and roof in an indoor scene. Accordingly, such fixed reference objects would also be contained in the three-dimensional background model generated according to the scene under surveillance. Each of the fixed reference objects occupies an area in the three-dimensional background model, for example, the areas for the walls, floor, and roof included therein. Also, the same areas are also included in a two-dimensional video image captured in the scene under surveillance. However, the information such as the size and coordinates of an area in the two-dimensional video image may be different from the information such as the size and coordinates of the corresponding area in the three-dimensional background model.

Therefore, in the embodiment of the present application, in order to deeply integrate the two-dimensional surveillance video into the three-dimensional background model, the electronic device can first divide, according to the grid information, a video image in the surveillance video into a plurality of image areas of corresponding sizes. For example, the video image in the surveillance video can be divided into a plurality of image areas of corresponding sizes according to the sizes of the image areas in the video image of the surveillance video included in the video grid information.

After the video image in the surveillance video is divided into a plurality of image areas, the electronic device can further adjust the image areas based on the area coordinates of the image areas in the three-dimensional background model, which are included in the video grid information. Specifically, the position, scale, and the like of each image area can be adjusted so that each image area fits with the corresponding area in the three-dimensional background model. For example, for each image area, a plurality of mark points therein can be selected, and the coordinates of the plurality of mark points can be used to identify the area coordinates of the image area in the three-dimensional background model.

For example, when the scene under surveillance is an indoor scene, the video grid information corresponding to the scene under surveillance can include the sizes of the walls, floor, and roof in the video image of the surveillance video, so that the electronic device can divide correspondingly, based on the video grid information, the surveillance video into a plurality of wall areas, a floor area, and a roof area. The video grid information can also include area coordinates, in the three-dimensional background model, of the wall areas, the floor area, and the roof area in the video image of the surveillance video. If the size of any of the wall areas in the video image is smaller than the size of the corresponding wall area in the three-dimensional background model, the electronic device can enlarge the wall area in the video image, so that the size of the wall area in the video image is equal to the size of the corresponding wall area in the three-dimensional background model.

S103, superimposing the adjusted image areas on areas with corresponding coordinates in the three-dimensional background model.

By means of dividing the surveillance video and adjusting the image areas obtained after the division, the image areas included in the surveillance video can fit with the corresponding areas in the three-dimensional background model.

The electronic device can thus superimpose the adjusted image areas on areas with corresponding coordinates in the three-dimensional background model. For example, the adjusted image areas can cover the areas with corresponding coordinates in the three-dimensional background model, so that the surveillance video is presented in the three-dimensional background model. A better three-dimensional presentation is thus provided.

In the method for three-dimensional presentation of a surveillance video provided in the embodiment of the present application, the video grid information includes sizes of image areas in a video image of the surveillance video, and area coordinates of the image areas in the three-dimensional background model. Each of the image areas can be adjusted based on the area coordinates of the image areas in the three-dimensional background model, which are included in the video grid information, so that the image areas can fit with the three-dimensional background model. The adjusted image areas are further superimposed on areas with corresponding coordinates in the three-dimensional background model. As such, the surveillance video can be deeply integrated with the three-dimensional background model. A better presentation of the surveillance video is provided.

In one implementation of the embodiment of the present application, the electronic device can transmit a preconfigured three-dimensional background model and video grid information corresponding to each scene under surveillance to each video capture device. The video capture device can locally store the received three-dimensional background model and the video grid information. In this case, after capturing a surveillance video, the video capture device can encapsulate the locally stored three-dimensional background model and video grid information in the captured surveillance video and transmit the three-dimensional background model and video grid information to the electronic device along with the surveillance video.

In this case, after acquiring the surveillance video, the electronic device can directly acquire the preconfigured three-dimensional background model and video grid information encapsulated in the surveillance video and corresponding to the scene in which the surveillance video is captured. Specifically, in the embodiment of the present application, the video capture device may transmit, for each key frame of the surveillance video, the three-dimensional background model and video grid information encapsulated in the surveillance video to the electronic device. Alternatively, in order to save the network resources occupied by data transmission, the video capture device may transmit the three-dimensional background model and video grid information only at the beginning of the transmission of the surveillance video.

In the above approach, the electronic device transmits the three-dimensional background model and video grid information to the video capture device. The video capture device needs to locally store the three-dimensional background model and the video grid information and encapsulate the three-dimensional background model and video grid information in the captured surveillance video. It should be understood that, for this purpose, the video capture device has to be configured to be capable of encapsulating the three-dimensional background model and video grid information in the captured surveillance video. Thus, the adaptability is low. In addition, in the case that the electronic device acquires a surveillance video captured in real time by a video capture device, the video capture device needs to, after capturing the surveillance video, encapsulate the three-dimensional background model and video grid information in the captured surveillance video before the transmission thereof. Such a process may affect the efficiency of the real time transmission of the surveillance video. However, the electronic device does not need to look up a three-dimensional background model corresponding to the scene under surveillance according to a scene under surveillance. Thus the accuracy of the three-dimensional background model obtained can be ensured.

In another implementation of the embodiment of the present application, to improve the adaptability of the method for three-dimensional presentation of a surveillance video as provided in the embodiment of the present application and improve the transmission efficiency of the surveillance video, the electronic device can store the preconfigured three-dimensional background model and video grid information in a preset storage space, such as the storage space of its own or a server. In addition, the identification information of the video capture device corresponding to the three-dimensional background model and video grid information can also be stored with the three-dimensional background model and video grid information.

In this case, once a surveillance video is acquired, the electronic device can first determine the identification information of a video capture device that captures the surveillance video, and then acquire, from the preset storage space, the three-dimensional background model and video grid information corresponding to the identification information.

Further, in this embodiment of the present application, the electronic device can preconfigure a three-dimensional background model corresponding to the scene under surveillance.

Specifically, the electronic device can first receive scene information input by a user, wherein the scene information includes at least the information about a size of the scene and information about the sizes and positions of fixed reference objects therein. For example, in the case that the scene under surveillance is an indoor scene, the scene information input by the user may include the length, width, and height of the room, and sizes and positions of the reference objects such as walls, floor, and roof of the room; in the case that the scene under surveillance is a street scene, the scene information input by the user may include the length and width of the street, and sizes and positions of reference objects such as important structures and trees around the street.

The electronic device can generate a corresponding three-dimensional background model according to the received scene information input by the user. In this embodiment of the present application, the prior arts may be employed by the electronic device to generate a corresponding three-dimensional background model according to the scene information input by the user, the process of which is omitted herein.

Further, in the embodiment of the present application, after generating a three-dimensional background model, the electronic device can also generate, for each scene under surveillance, video grid information corresponding to the scene under surveillance and the three-dimensional background model.

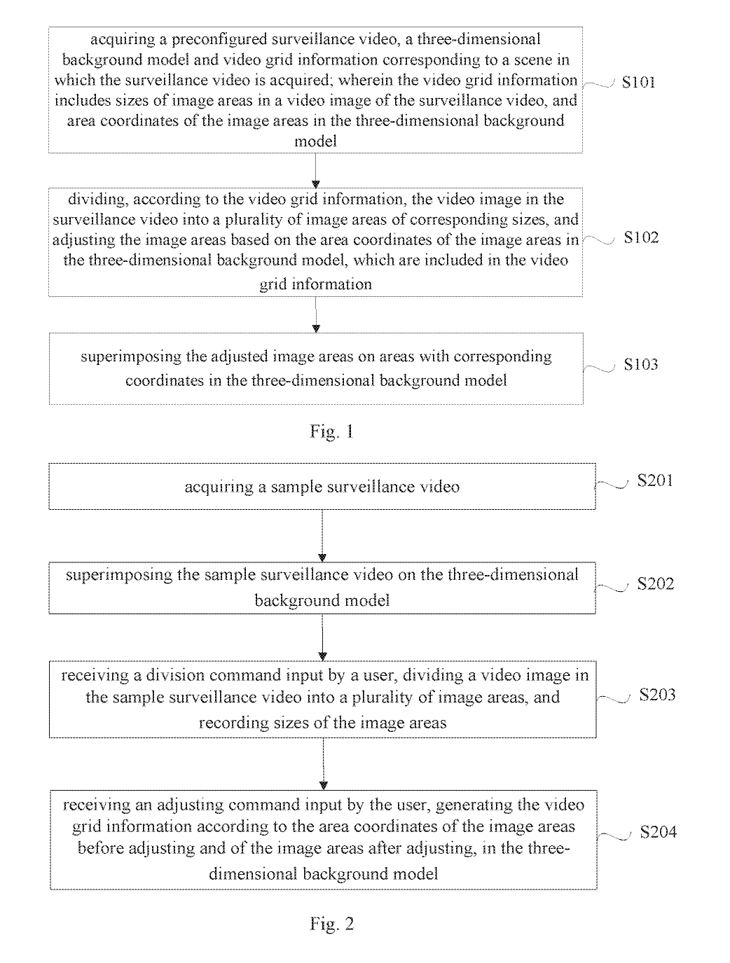

Specifically, as shown in FIG. 2, the method for three-dimensional presentation of a surveillance video provided by an embodiment of the present application further includes the following steps:

S201, acquiring a sample surveillance video.

In the embodiment of the present application, after the electronic device generates a corresponding three-dimensional background model for any scene under surveillance, when generating the video grid information, the electronic device can first acquire a sample surveillance video.

For example, when a corresponding video capture device for any scene under surveillance has been set (i.e., a lens of the video capture device does not rotate, the position is fixed, and the focal length remains unchanged), the surveillance video captured by the video capture device can act as a sample surveillance video used to generate the video grid information corresponding to the scene under surveillance. Parameters that the video capture device uses to capture the sample surveillance video are the same as those used to capture surveillance videos during its normal operation. The parameters include a shooting angle, shooting position, focal length and so forth.

S202, superimposing the sample surveillance video on the three-dimensional background model.

In the embodiment of the present application, the electronic device can superimpose the sample surveillance video, once acquired, on the preconfigured three-dimensional background model to generate video grid information corresponding to the three-dimensional background model.

S203, receiving a division command input by a user, dividing a video image in the sample surveillance video into a plurality of image areas, and recording sizes of the image areas.

In the embodiment of the present application, after the sample surveillance video has been superimposed on the three-dimensional background model, the user can input, according to the scene under surveillance corresponding to the present three-dimensional background model, a division command to divide a video image in the sample surveillance video.

Accordingly, the electronic device can receive the division command input by the user to divide the video image in the sample surveillance video into a plurality of image areas, and record the sizes of the image areas.

For example, in the case that the scene under surveillance is an indoor scene, the division command input by the user may be directed to divide the video image in the sample surveillance video into a plurality of wall areas, at least one floor area, and at least one roof area corresponding to areas included in the three-dimensional background model. After receiving the division command, the electronic device can accordingly divide the video image in the sample surveillance video into a plurality of wall areas, at least one floor area, and at least one roof area, and further record the sizes of the image areas.

As described above, the parameters that the video capture device uses to capture the sample surveillance video are the same as those used to capture surveillance videos during its normal operation. Accordingly, the sizes and positions of image areas in the video image of the sample surveillance video captured by the video capture device are the same as those of surveillance videos captured during its normal operation. After the video image in the sample surveillance video has been divided into a plurality of image areas corresponding to the areas included in the three-dimensional background model and sizes of the image areas have been recorded, the electronic device can divide, upon receiving a surveillance video and a command of dividing the video image in the surveillance video, the video image in the surveillance video into a plurality of image areas of the same sizes as the recorded sizes of the image areas. In other words, the video image in the surveillance video can be divided into a plurality of image areas corresponding to the areas included in the three-dimensional background model.

S204, receiving an adjusting command input by the user, generating the video grid information according to the area coordinates of the image areas before adjusting and of the image areas after adjusting, in the three-dimensional background model.

In the embodiment of the present application, after the sample surveillance video has been divided into a plurality of image areas, the user can input, according to the areas included in the present three-dimensional background model, an adjusting command to adjust the image areas. For example, the adjusting command may be directed to adjust positions and scaling of the image areas so that the image areas fit with the corresponding areas in the three-dimensional background model.

Therefore, the electronic device can receive the adjusting command input by the user, and generate video grid information according to the area coordinates of the image areas, before and after adjusting, in the three-dimensional background model.

For example, in the case that the surveillance scene is an indoor scene, the electronic device can divide, according to the division command input by the user, the sample video into a plurality of wall areas, at least one floor area, and at least one roof area. For any wall area in the video image, if the size of the wall area is smaller than that of a corresponding wall area in the three-dimensional background model, the user can input a command to enlarge the wall area. The electronic device can enlarge the size of the wall area upon receiving the command, so that the size of the wall area in the video image is the same as that in the three-dimensional background model. Alternatively, vertices of the wall area in the video image can be adjusted to coincide with those of the corresponding wall area in the three-dimensional background model according to a position adjusting command input by the user.

It could be understood that, for one same image area, the electronic device may adjust the image area for one or more times. In addition, the electronic device may adjust, according to the adjusting command input by the user, one or more of the image areas included in the video image.

After the electronic device has adjusted the image areas, the video grid information can be generated according to the area coordinates of the image areas, before and after adjusting, in the three-dimensional background model.

In one implementation, after each time the electronic device completes the adjustment of an image area, a prompt box can pop up to prompt the user whether to input confirmation information. The absence of confirmation information received from the user may indicate that the user wants to further adjust the image area. Accordingly, the electronic device may not generate the video grid information. Reception of confirmation information from the user may indicate that the adjusting of the image area is finished. The electronic device can then generate the video grid information according to the area coordinates of the image areas, before and after adjusting, in the three-dimensional background model (i.e., coordinates of the present image areas in the three-dimensional background model).

It could be understood that, after the electronic device finished the adjusting of the image areas of the sample surveillance video so that the adjusted image areas fit with the corresponding areas in the three-dimensional background model, and generated the video grid information according to the area coordinates of the image areas, before and after adjusting, in the three-dimensional background model, when receiving a surveillance video and adjusting image areas in a video image of the surveillance video, the corresponding image areas in the surveillance video received can be adjusted in the same manner in which the image areas of the sample surveillance video have been adjusted. As such, the adjusted image areas of the surveillance video fit with corresponding areas in the three-dimensional background model. A better three-dimensional presentation of the surveillance video can be provided.

In the method provided in the embodiment of the present application, a three-dimensional background model and video grid information can be preconfigured. The video grid information can include sizes of image areas in a video image of the surveillance video, and area coordinates of image areas in the three-dimensional background model. The image areas in the surveillance video can be adjusted according to the area coordinates of the image areas in the three-dimensional background model, so that the image areas fit with the three-dimensional background model. The adjusted image areas can further be superimposed on areas with corresponding coordinates in the three-dimensional background model. A deep integration of the surveillance video with the three-dimensional background model is achieved. A better three-dimensional presentation of the surveillance video is provided.

In accordance with the method embodiments above, a corresponding apparatus embodiment is also provided in the present application.

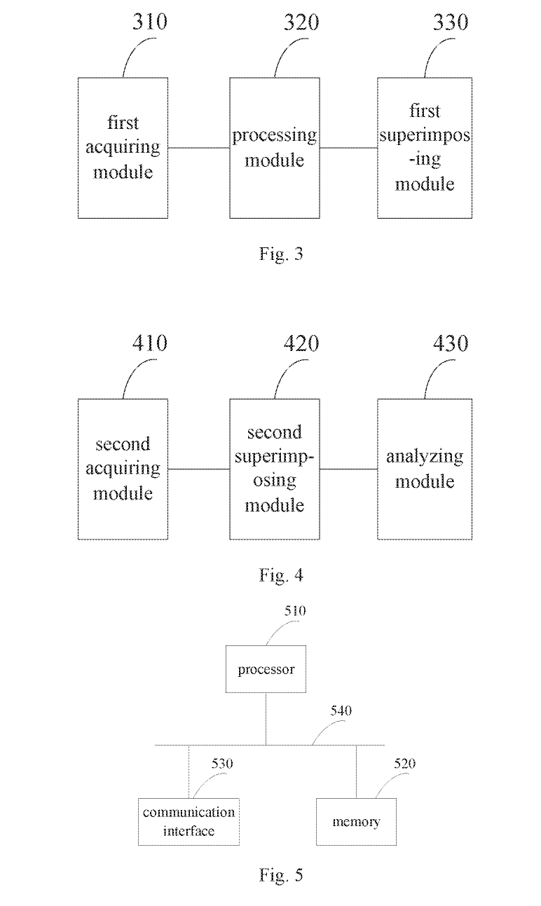

FIG. 3 illustrates an apparatus for three-dimensional presentation of a surveillance video provided by an embodiment of the present application, applicable to an electronic device. The apparatus includes:

a first acquiring module 310, configured to acquire a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model;

a processing module 320, configured to divide, according to the video grid information, the video image of the surveillance video into a plurality of image areas of corresponding sizes, and adjust the image areas based on the area coordinates of the image areas in the three-dimensional background model, which are included in the video grid information; and

a first superimposing module 330, configured to superimpose the adjusted image areas on areas with corresponding coordinates in the three-dimensional background model.

In the embodiment of the apparatus for three-dimensional presentation of a surveillance video, the video grid information includes sizes of image areas in a video image of the surveillance video, and area coordinates of the image areas in the three-dimensional background model. Each of the image areas can be adjusted based on the area coordinates of the image areas in the three-dimensional background model, which are included in the grid information, so that the image areas can fit with the three-dimensional background model. The adjusted image areas are further superimposed on areas with corresponding coordinates in the three-dimensional background model. As such, the surveillance video can be deeply integrated with the three-dimensional background model. A better presentation of the surveillance video is provided.

Further, the first acquiring module 310 includes:

a first acquiring sub-module (now shown), configured to acquire a preconfigured three-dimensional background model and video grid information corresponding to a scene in which the surveillance video is captured and encapsulated in the surveillance video; and

a second acquiring sub-module (now shown), configured to determine identification information of a video capture device that captures the surveillance video, and then acquire, from a preset storage space, a three-dimensional background model and video grid information corresponding to the identification information.

Further, the apparatus further includes:

a transmitting module (now shown), configured to transmit the three-dimensional background model and video grid information to the video capture device that captures the surveillance video, so as to cause the video capture device to encapsulate the three-dimensional background model and video grid information in the surveillance video.

Further, the apparatus further includes:

a receiving module (now shown), configured to receive scene information input by a user, wherein the scene information includes at least information about a size of the scene and information about the sizes and positions of fixed reference objects in the scene; and

a first generating module (now shown), configured to generate the three-dimensional background model according to the scene information input by the user.

Further, as shown in FIG. 4, the apparatus for three-dimensional presentation of a surveillance video provided by the embodiment of the present application further includes:

a second acquiring module 410, configured to acquire a sample surveillance video; a second superimposing module 420, configured to superimpose the sample surveillance video on the three-dimensional background model;

an analyzing module 430, configured to receive a division command input by the user, divide a video image in the sample surveillance video into a plurality of image areas, and record sizes of the image areas; and

a second generating module 440, configured to receive an adjusting command input by the user, generate the video grid information according to the area coordinates of the image areas before adjusting and of the image areas after adjusting, in the three-dimensional background model.

In the apparatus provided by the embodiment of the present application, a three-dimensional background model and video grid information corresponding to a scene under surveillance can be preconfigured. The video grid information can include sizes of image areas in a video image of the surveillance video, and area coordinates of image areas in the three-dimensional background model. The image areas can be adjusted according to the area coordinates of the image areas in the three-dimensional background model, so that the image areas fit with the three-dimensional background model. The adjusted image areas can further be superimposed on areas with corresponding coordinates in the three-dimensional background model. A deep integration of the surveillance video with the three-dimensional background model is achieved. A better three-dimensional presentation of the surveillance video is provided.

Accordingly, a storage medium is also provided in the present application. The storage medium is configured to store executable program code, which performs the method for three-dimensional presentation of a surveillance video when being executed. The method includes:

acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model;

dividing, according to the video grid information, the video image of the surveillance video into a plurality of image areas of corresponding sizes, and adjusting the image areas based on the area coordinates of the image areas in the three-dimensional background model, which are included in the video grid information; and

superimposing the adjusted image areas on areas with corresponding coordinates in the three-dimensional background model.

In the embodiment of the present application, the video grid information includes sizes of image areas in a video image of the surveillance video, and area coordinates of the image areas in the three-dimensional background model. Each of the image areas can be adjusted based on the area coordinates of the image areas in the three-dimensional background model, which are included in the video grid information, so that the image areas can fit with the three-dimensional background model. The adjusted image areas are further superimposed on areas with corresponding coordinates in the three-dimensional background model. As such, the surveillance video can be deeply integrated with the three-dimensional background model. A better presentation of the surveillance video is provided.

Accordingly, an application program is provided in the present application. The application program is configured to perform the method for three-dimensional presentation of a surveillance video when being executed. The method includes:

acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model;

dividing, according to the video grid information, the video image of the surveillance video into a plurality of image areas of corresponding sizes, and adjusting the image areas based on the area coordinates of the image areas in the three-dimensional background model, which are included in the video grid information; and

superimposing the adjusted image areas on areas with corresponding coordinates in the three-dimensional background model.

In the embodiment of the present application, the video grid information includes sizes of image areas in a video image of the surveillance video, and area coordinates of the image areas in the three-dimensional background model. Each of the image areas can be adjusted based on the area coordinates of the image areas in the three-dimensional background model, which are included in the video grid information, so that the image areas can fit with the three-dimensional background model. The adjusted image areas are further superimposed on areas with corresponding coordinates in the three-dimensional background model. As such, the surveillance video can be deeply integrated with the three-dimensional background model. A better presentation of the surveillance video is provided.

Accordingly, an electronic device is provided in the present application, as shown in FIG. 5. The electronic device includes:

a processor 510, a memory 520, a communication interface 530, and a bus 540; wherein,

the processor 510, the memory 520 and the communication interface 530 connect and communicate with each other through the bus 540;

the memory 520 is configured to store executable program code;

the processor 510 is configured to read the executable program code stored in the memory to execute a program corresponding to the executable program code, in order to perform the method for three-dimensional presentation of a surveillance video. The method includes:

acquiring a surveillance video, a preconfigured three-dimensional background model and video grid information corresponding to a scene in which the surveillance video is captured; wherein the video grid information includes sizes of image areas in a video image of the surveillance video, and area coordinates of the image areas in the three-dimensional background model;

dividing, according to the video grid information, the video image of the surveillance video into a plurality of image areas of corresponding sizes, and adjusting the image areas based on the area coordinates of the image areas in the three-dimensional background model, which are included in the video grid information; and

superimposing the adjusted image areas on areas with corresponding coordinates in the three-dimensional background model.

In the embodiment of the present application, the video grid information includes sizes of image areas in a video image of the surveillance video, and area coordinates of the image areas in the three-dimensional background model. Each of the image areas can be adjusted based on the area coordinates of the image areas in the three-dimensional background model, which are included in the video grid information, so that the image areas can fit with the three-dimensional background model. The adjusted image areas are further superimposed on areas with corresponding coordinates in the three-dimensional background model. As such, the surveillance video can be deeply integrated with the three-dimensional background model. A better presentation of the surveillance video is provided.

For the apparatus/storage medium/application/electronic device embodiment, since it is basically similar to the method embodiment, the description is relatively simple, and for related parts, reference can be made to the partial description of the method embodiment.

It should be noted that in the claims and the specification, relationship terms such as “first”, “second” and the like are only used to distinguish one entity or operation from another entity or operation, and do not necessarily require or imply that there is any such actual relationship or order between those entities or operations. Moreover, the terms “comprise” “include” or any other variants are intended to cover a non-exclusive inclusion, such that processes, methods, objects or devices including a series of elements include not only those elements, but also other elements not specified or the elements inherent to those processes, methods, objects or devices. Without further limitations, elements limited by the phrase “include(s) a . . . ” do not exclude that there are other identical elements in the processes, methods, objects or devices that include that element.

The various embodiments in the specification are described in an interrelated way, and identical or similar parts in various embodiments can refer to one another. In addition, the description for each embodiment focuses on the differences from other embodiments. In particular, the embodiment of the system is described briefly, since it is substantially similar to the embodiment of the method, and the related contents can refer to the description of the embodiment of the method.

Those of ordinary skill in the art can appreciate that all or a part of the embodiments described above can be implemented by instructing relevant hardware through a program. The program can be stored in a computer readable storage medium such as a ROM/RAM, magnetic disk, and optic disk.

What has been described above are merely preferred embodiments of the present application, and are not used to limit the scope of protection of the present application. Any modification, equivalent replacement or improvement made within the spirit and principle of the present application falls within the scope of protection of the present application.

1. A method for three-dimensional presentation of a surveillance video, which is applicable to an electronic device, comprising:
acquiring a surveillance video, a preconfigured three-dimensional background model and video grid information corresponding to a scene in which the surveillance video is captured; wherein the video grid information comprises sizes of image areas in a video image of the surveillance video, and area coordinates of the image areas in the three-dimensional background model;
dividing, according to the video grid information, the video image of the surveillance video into a plurality of image areas of corresponding sizes, and adjusting the image areas based on the area coordinates of the image areas in the three-dimensional background model, which are comprised in the video grid information; and
superimposing the adjusted image areas on areas with corresponding coordinates in the three-dimensional background model.

2. The method of claim 1, wherein acquiring a preconfigured three-dimensional background model and video grid information corresponding to a scene in which the surveillance video is captured comprises:
acquiring a preconfigured three-dimensional background model and video grid information that are encapsulated in the surveillance video and correspond to the scene in which the surveillance video is captured; and
determining identification information of a video capture device that captures the surveillance video, and then acquiring, from a preset storage space, a three-dimensional background model and video grid information corresponding to the identification information.

3. The method of claim 2, wherein configuring the three-dimensional background model comprises:
receiving scene information input by a user, wherein the scene information comprises at least information about a size of the scene and information about sizes and positions of fixed reference objects in the scene; and
generating the three-dimensional background model according to the scene information input by the user.

4. The method of claim 3, wherein configuring the video grid information comprises:
acquiring a sample surveillance video;
superimposing the sample surveillance video on the three-dimensional background model;
receiving a division command input by the user, dividing a video image in the sample surveillance video into a plurality of image areas, and recording sizes of the image areas; and
receiving an adjusting command input by the user, generating the video grid information according to the area coordinates of the image areas before adjusting and of the image areas after adjusting, in the three-dimensional background model.

5. The method of claim 2, wherein when acquiring a preconfigured three-dimensional background model and video grid information that are encapsulated in the surveillance video and correspond to the scene in which the surveillance video is captured, in the process of acquiring a surveillance video, a preconfigured three-dimensional background model and video grid information corresponding to a scene in which the surveillance video is captured, the method further comprises:
transmitting the three-dimensional background model and video grid information to the video capture device that captures the surveillance video, so as to cause the video capture device to encapsulate the three-dimensional background model and video grid information in the surveillance video.

6. An apparatus for three-dimensional presentation of a surveillance video, which is applicable to an electronic device, comprising:
a first acquiring module, configured to acquire a preconfigured surveillance video, a three-dimensional background model and video grid information corresponding to a scene in which the surveillance video is captured; wherein the video grid information comprises sizes of image areas in a video image of the surveillance video, and area coordinates of the image areas in the three-dimensional background model;
a processing module, configured to divide, according to the video grid information, the video image of the surveillance video into a plurality of image areas of corresponding sizes, and adjust the image areas based on the area coordinates of the image areas in the three-dimensional background model, which are comprised in the video grid information; and
a first superimposing module, configured to superimpose the adjusted image areas on areas with corresponding coordinates in the three-dimensional background model.

7. The apparatus of claim 6, wherein the first acquiring module comprises:
a first acquiring sub-module, configured to acquire a preconfigured three-dimensional background model and video grid information that are encapsulated in the surveillance video and correspond to the scene in which the surveillance video is captured; and
a second acquiring sub-module, configured to determine identification information of a video capture device that captures the surveillance video, and then acquire, from a preset storage space, a three-dimensional background model and video grid information corresponding to the identification information.

8. The apparatus of claim 7, wherein the apparatus further comprises:
a receiving module, configured to receive scene information input by a user, wherein the scene information comprises at least information about a size of the scene and information about sizes and positions of fixed reference objects in the scene; and
a first generating module, configured to generate the three-dimensional background model according to the scene information input by the user.

9. The apparatus of claim 8, wherein the apparatus further comprises:
a second acquiring module, configured to acquire a sample surveillance video;
a second superimposing module, configured to superimpose the sample surveillance video on the three-dimensional background model;
an analyzing module, configured to receive a division command input by the user, divide a video image in the sample surveillance video into a plurality of image areas, and record sizes of the image areas; and
a second generating module, configured to receive an adjusting command input by the user, generate the video grid information according to the area coordinates of the image areas before adjusting and of the image areas after adjusting, in the three-dimensional background model.

10. The apparatus of claim 7, wherein the apparatus further comprises:
a transmitting module, configured to transmit the three-dimensional background model and video grid information to the video capture device that captures the surveillance video, so as to cause the video capture device to encapsulate the three-dimensional background model and video grid information in the surveillance video.

11. A non-transitory storage medium, configured to store executable program code, which performs the method for three-dimensional presentation of a surveillance video of claim 1 when being executed.

12. (canceled)

13. An electronic device, comprising:
a processor, a memory, a communication interface, and a bus;
the processor, the memory and the communication interface connect and communicate with each other through the bus;
the memory is configured to store executable program code;
the processor is configured to read the executable program code stored in the memory to execute the executable program code, in order to perform the method for three-dimensional presentation of a surveillance video of claim 1.
